(19) United States
(12) Patent Application Publication
(10) Pub. No.: US 2014/0207559 A1
(43) Pub. Date: Jul. 24, 2014

(54) SYSTEM AND METHOD FOR UTILIZING CAPTURED EYE DATA FROM MOBILE DEVICES

(71) Applicant: Millennial Media, Inc., Boston, MA (US)

(72) Inventors: Steven McCord, Washington, DC (US); John Christopher Brandenburg, Phoenix, MD (US); Bob Hammond, Exeter, NH (US); Shrikanth B. Mysore, Littleton, MA (US); Matthew A. Tengler, Upton, MA (US); Andrew Groh, Cambridge, MA (US); Adam Soroca, Cambridge, MA (US); Richard J. Lynch, JR., Cambridge, MA (US); Benjamin M. Gordan, Hingham, MA (US)

(21) Appl. No.: 14/159,426

(22) Filed: Jan. 20, 2014

Related U.S. Application Data
(60) Provisional application No. 61/756,156, filed on Jan. 24, 2013.
(60) Provisional application No. 61/800,505, filed on Mar. 15, 2013.

(51) Int. Cl. G06Q 30/02

(52) U.S. Cl. CPC G06Q 30/0242
USPC 705/14.41

(57) ABSTRACT

A device for analyzing eye data captured via the device, the device configured to perform the steps of (a) displaying an advertisement and other content on the display; (b) capturing one or more images using the camera, wherein the one or more images depict at least one or more eyes of a user of the device; (c) detecting the one or more eyes in the one or more captured images; (d) determining based at least upon the one or more captured images that the one or more eyes are focused for a predetermined amount of time on the advertisement as opposed to the other content; and (e) based upon the determination in step (d), displaying on the display an item contextually related to the advertisement and different from the other content, wherein the item is (i) text; (ii) a picture; or (iii) a video.

### CROSS REFERENCE TO RELATED APPLICATIONS

This application claims the benefit of U.S. Provisional Pat. App. No. 61/756,156 filed Jan. 24, 2013, and titled “Methods and Systems for Utilizing Captured Eye Data” and U.S. Provisional Pat. App. No. 61/800,505 filed Mar. 15, 2013, and titled “System For Predicting and Achieving Latent Conversions Through Mobile Device Use and System For Contextual, Publisher, and Advertiser Classification,” the contents of which are hereby incorporated herein by reference in their entirety.

### BACKGROUND OF THE INVENTION

1. Field of the Invention

This disclosure relates to the field of mobile communications and more particularly to improved methods and systems directed to targeting advertising to mobile and non-mobile communication devices and achieving conversions therein.

2. Description of Related Art

Web-based search engines, readily available information, and entertainment mediums have proven to be one of the most significant uses of computer networks such as the Internet. As online use increases, users seek more and more ways to access the Internet. Users have progressed from desktop and laptop computers to cellular phones and smartphones for work and personal use in an online context. Now, users are accessing the Internet not only from a single device, but from their televisions and gaming devices, and most recently, from tablet devices. Internet-based advertising techniques are currently unable to optimally target and deliver content, such as advertisements, for a mobile communication facility (e.g., cellular phone, smartphone, tablet device, portable media player, laptop or notebook computer, or wearable device, such as a smart watch, smart glasses/contact lenses) because the prior art techniques are specifically designed for the Internet in a non-mobile device context. These prior art techniques fail to take advantage of unique data assets derived from telecommunications aspects, such as interactions with devices.

Devices, such as mobile devices, often allow users to interact with objects displayed on the devices. Objects may include, for example, advertisements, hyperlinks, pictures, video, and text. Conventionally, objects displayed on a device are interacted with in a variety of ways including, for example, using a mouse or touch screen. For example, if a user selects an advertisement displayed on a device using a mouse, an Internet browser executing on the device may be caused to navigate to an advertiser's website or the device may be caused to perform some other action. Mobile devices are often integrated with one or more cameras that can provide image data (i.e., photograph or video data).

### BRIEF DESCRIPTION OF THE DRAWINGS

FIG. 1 is a process flow diagram for delivery of HTML content to a device based on analyzed user eye gaze/movement;

FIG. 2 is a process flow diagram for delivery video content to a device based on analyzed user eye gaze/movement;

FIG. 3 is a process flow diagram for delivery of analytic data of user eye gaze/movement in the form of a heat map; and

FIG. 4 is an example of a heat map indicating the extent of user eye gaze/movement with respect to various areas of a display.

### SUMMARY OF THE INVENTION

A device with a front-facing camera may acquire images of a user's face at predetermined time intervals while the user interacts with the device. The techniques described herein utilize such image data to derive eye data associated with eyes of a user captured by the camera to determine how the user is interacting with the device. While certain techniques are described herein with reference to a mobile device, the techniques may be applied to any device with a camera.

In one embodiment, the invention includes a device for analyzing eye data captured via the device, the device including a display, a camera, one or more processors, and a memory with instructions stored thereon which, when executed by the one or more processors, causes the device to perform the steps of: (a) displaying an advertisement and other content on the display; (b) capturing one or more images (e.g., consecutive series of images with corresponding time stamp data; or use of video stream data) using the camera, wherein the one or more images depict at least one or more eyes (or inherent aspects of the eye such as its surrounding muscular structure, the iris, pupil, eyelid height/distances between eyelids) of a user of the device; (c) detecting the one or more eyes in the one or more captured images; (d) determining based at least upon the one or more captured images that the one or more eyes are focused for a predetermined amount of time (e.g., a few seconds) on the advertisement as opposed to the other content (e.g., textual/HTML, graphical content, video, gaming structure, etc. within the webpage or app in which advertisement appears); and (e) based upon the determination in step (d), displaying on the display an item contextually related to the advertisement and different from the other content, wherein the item is: (i) text; (ii) a picture; or (iii) a video. The text may include additional information about a product or service depicted in the advertisement. The additional information may include descriptive information about the product or service and/or an incentive/promotional content related to the product or service. Thus, the item could be another advertisement.

In another embodiment, the invention includes a device for analyzing eye data captured via the device, the device including a display, a camera, one or more processors, and a memory with instructions stored thereon which, when executed by the one or more processors, causes the device to perform the steps of: (a) displaying an advertisement and other content on the display; (b) capturing one or more images using the camera, wherein the one or more images depict at least one or more eyes of a user of the device; (c) detecting the one or more eyes in the one or more captured images; (d) determining based at least upon the one or more captured images that the one or more eyes are focused for a predetermined amount of time on the advertisement as opposed to the other content; and (e) based upon the determination in step (d), displaying on the display an expanded version of the advertisement. The expanded version may be an advertisement of the blown-up, overlay/hover, full-screen, higher resolution, etc. variety. Such an expanded version could contain similar or substantially similar information (e.g., containing further information that could not fit within the initial advertisement).

In another embodiment, the invention includes a device for analyzing eye data captured via the device, the device comprising a display, a camera, one or more processors, and a memory with instructions stored thereon which, when executed by the one or more processors, causes the device to perform the steps of: (a) displaying on the display a webpage containing: (i) a graphical element depicting an item (e.g., clothing, a movie, a game, an electronic device, or real estate) for which a corresponding or similar real-life item is available for purchase; (ii) other content; (b) capturing one or more images using the camera, wherein the one or more images depict at least one or more eyes of a user of the device; (c) detecting the one or more eyes in the one or more captured images; (d) determining based at least upon the one or more captured images that the one or more eyes are focused for a predetermined amount of time on the item as opposed to the other content; and (e) based upon the determination in step (d), displaying on the display content contextually related to the item and different from the other content, wherein the contextually related content is: (i) an incentive (e.g., sales price discount, a coupon, or a merchandise credit) associated with the corresponding or similar real-life item; (ii) a purchase opportunity for the corresponding or similar real-life item; or (iii) an availability of the corresponding or similar real-life item within a predefined geographical region (e.g., zip code, an area code, a city, or a predefined radius distance) associated with the device.

Advertisement or other content that is triggered to be displayed after eye focus detection has been established may have been received in connection with the original ad or content that was previously viewed (e.g., to be cached on the device) or it may be received after the eye focus detection has been established. In addition to a predetermined amount of time trigger or as a function separate therefrom, an additional advertisement or content may be displayed if it is determined that that initial content that was focused upon was focused multiple times (e.g., within a predetermined time frame; after viewing the initial content, then some other content, and then returning focus once again to the initial content).

It is to be understood that that any initial advertisements and/or advertisements/content displayed after a focus determination has been made may be influenced based on targeted advertising concepts (e.g., behavioral, demographic, contextual, etc. targeting)

The device may be a cellular phone, a smartphone, a tablet, a portable media player, a laptop or notebook computer, a smart watch, smart glasses; or contact lenses. The device may include an accelerometer and/or a gyroscope.

To overcome the deficiencies of the prior art, what is needed, and has not heretofore been developed, is a system associated with telecommunications networks and fixed mobile convergence applications that is enabled to select and target advertising content readable by a plurality of mobile and non-mobile communication facilities and that is available from across a number of advertising inventories.

The present invention includes a system for predicting a latent conversion, the system having one or more non-transitory computer readable mediums having stored thereon instructions which, when executed by one or more processors of the computer system, causes the one or more processors to provide a targeted mobile advertisement, the system comprising the steps of: (a) identifying by operating system a cluster of mobile communication devices accessed by a group of users; (b) receiving interaction information relating to the cluster; (c) receiving a datum associated with the group of users, wherein the datum corresponds to conversion information relating to the group of users; (d) weighting a mobile advertisement based at least in part on the interaction information and the conversion information relating to the group of users; and (e) providing the weight as a parameter for use in delivering the mobile advertisement to the cluster of mobile communication devices.

These and other features and characteristics of the present invention, as well as the methods of operation and functions of the related elements of structures and the combination of parts and economies of manufacture, will become more apparent upon consideration of the following description and the appended claims.

### DETAILED DESCRIPTION OF THE INVENTION

Utilizing Captured Eye Data from Mobile Devices

In some embodiments, data from a camera of a device can be used to determine a location on the device display focused on by a user's eyes (i.e., eye gaze). For example, in some embodiments, eye gaze may be determined by comparing a captured image of a user's face to a database of template images of a face, each template image having an eye gaze and corresponding metadata. In some embodiments, template images may be captured during a training phase. In varying embodiments, the training phase may be completed, for example, by a user of a device and/or another individual. The training phase may also be completed using a different device. For example, during a training phase, a device may be positioned in one or more predetermined locations and orientations relative to a face. Template images may then be captured while an individual looks at one or more objects displayed on the device. For example, an individual may be instructed to look at a graphic positioned in one or more predetermined locations on the device display at predetermined times. In another example, an individual may be instructed to follow a graphic with the individual's eyes as it moves on the device's display. In yet another example, for devices with a touch-sensitive display, template images may be captured when an individual presses locations on the touch-sensitive display as instructed or during ordinary use. In these embodiments, each captured template image may have a specific eye gaze that corresponds to a location on the device's display focused on by a user at the time the template image was captured. In some embodiments, data associated with an eye gaze captured in a template image, as described below, may be stored for the template image as metadata. Other metadata may include, for example, data associated with the image itself, such as image size and quality.

In some embodiments, template images may be analyzed to derive, for example, vertical eye gaze and horizontal eye gaze of eyes captured in the template image among other data (e.g., image quality). If a template image is captured by a device that includes a front-facing camera positioned directly perpendicular to the volunteer's eyes, the vertical eye gaze θᵥ may be determined for a given template image by calculating θᵥ=2 tan⁻¹(v/2d), where v is representative of the vertical distance between the camera and the displayed object or detected location press and d is representative of the distance of the device's camera to the captured eyes. Similarly, the horizontal eye gaze θₕ may be determined for a given template image by calculating θₕ=2 tan⁻¹ (h/2d), where h is representative of the horizontal distance between the camera and the displayed object or detected location press and d is representative of the distance of the device's camera to the captured eyes. Vertical and horizontal eye gaze may be determined either locally on the device that captures the template images or remotely by one or more other devices.

In some embodiments, template images may be processed in a variety of ways before being stored. For example, template images may be passed through one or more filters that emphasize the gaze of an eye, such as a filter that increases image contrast. For instance, in some embodiments, template images are passed through a threshold filter such that all pixels below a threshold value are converted to a first value and all pixels equal to or greater than the threshold value are converted to a second value. Moreover, to save storage space and processing time, the template images may be cropped to only include, or approximately include, a portion of a given template image that contains eyes. The processed template images may be stored locally on the device that captures the template images or remotely on one or more other devices.

When an image is captured on a mobile device, the captured image may be compared to template images in a number of ways to determine a match. For example, a direct comparison may be performed between corresponding pixels of the captured image and a given template image. The resulting number of matching pixels may then indicate the degree of similarity of the two images. The template image most similar to the captured image may then be selected as representative of the eye gaze of the captured image. In some embodiments, the vertical eye gaze θ_{v,c} of the captured image may be set to equal the vertical eye gaze θᵥ of the selected template image. Likewise, the horizontal eye gaze θ_{h,c} of the captured image may be set to equal the horizontal eye gaze θₕ of the selected template image. In embodiments in which the template images are passed through a threshold filter, the captured image may also be passed through a threshold filter prior to comparison. By comparing thresholded versions of the captured image and the template images, small differences may be filtered out such that only more significant differences are detected. Additionally, in some embodiments, a mask that approximately corresponds to the shape of an eye may be applied to the comparison, such that only pixel differences at or near an eye region are counted. In some embodiments, additional or alternative methods of comparing a captured image to template images may instead or also be used, such as, for example, comparing the curvature of the iris, comparing the curvature of the pupil, or comparing the eyelid height.

In some embodiments, eye gaze determined for a captured image, as described above, may be used to determine where a user is looking on a device display. In some embodiments, in order to accurately determine the corresponding location of a device display that is focused on by a user, the location of the camera on the device (e.g., one centimeter above the top of the center of the device display; one centimeter to the left of, and one centimeter above, the top of the center of the device display; or one centimeter to the right of, and one centimeter above, the top of the center of the device display) and, in certain embodiments, orientation of the camera on the device, is determined, for example, by accessing camera location data stored locally or remotely on one or more other devices. The stored camera location data may, for example, be provided by a manufacturer of the device and/or determined by a third party.

In addition, in some embodiments, in order to accurately determine the corresponding location of a device display that is focused on by a user, the distance of the camera to the eyes in the captured image may also be determined For example, in some embodiments, an approximate distance may be calculated using one or more sensors or other components of the device (e.g., proximity sensor, camera). In other embodiments, an approximate distance may be calculated by measuring facial characteristics (e.g., a vertical distance between a face's chin to the top of the face or a vertical distance between a face's mouth and eyes), comparing the measured facial characteristics to average facial characteristics at different distances, and determining the distance of the device to the captured eyes as corresponding to the most similar average facial characteristics. In some embodiments, facial characteristics of a user of a device (e.g., determined by using an image captured during a training phase) may be used instead of or in addition to average facial characteristics.

If the camera is approximately perpendicular and centered to the captured eyes, a vertical distance v and horizontal distance h from the camera to the location on the device display focused on by the eyes may be determined by calculating v=2d tan(θ_{v,c}/2) and h=2d tan(θ_{h,c}/2), where d is representative of the distance of the device to the captured eyes, θ_{v,c} is representative of the vertical eye gaze of the captured image, and θ_{h,c} is representative of the horizontal eye gaze of the captured image. Using the determined vertical distance v and horizontal distance h from the camera to the location on the device display focused on by the eyes, and in some embodiments the camera location, the location of a device display that is focused on by a user may be determined In some embodiments, if the camera is not approximately perpendicular and/or centered to the captured eyes, adjustments to the above calculations may be made. For example, if it is determined that the camera is perpendicular, but offset, to the captured eyes, the determined vertical distance v and horizontal distance h from the camera to the location on the device display focused on by the eyes may be adjusted to account for the offset. For example, if it is determined that the camera is perpendicular to the captured eyes, but is offset to the left or right of the captured eyes by an offset distance, then the offset distance may be added to, or subtracted from, h to correct for the offset. Likewise, for example, if it is determined that the camera is perpendicular to the captured eyes, but is offset downwards or upwards from the captured eyes by an offset distance, then the offset distance may be added to, or subtracted from, v to correct for the offset.

In some embodiments, a device may comprise an accelerometer and/or a gyroscope. An accelerometer may provide the device with data regarding the device's acceleration in one, two, or three dimensions. A gyroscope may provide the device with data regarding the device's rotation with respect to one, two, or three axes. In some embodiments, data from the accelerometer and/or gyroscope may be used to determine the spatial position and/or angular position of the device relative to an individual's eyes. In some embodiments, the spatial position and/or angular position of the device may be used in the determination of the vertical distance v and horizontal distance h from the camera to the location on the device display focused on by the eyes. For example, if the device is not perpendicular to the captured eyes, the vertical distance v and horizontal distance h determined in the manner described above may be adjusted to account for the device's angular position.

Alternative methods of determining a location of a device display that is focused on by a user may also be implemented that do not require template images. For example, in some embodiments, vertical and horizontal eye gaze of a captured image can be determined by calculating measurements of eyes in a captured image (e.g., the curvature of the iris, the curvature of the pupil, and/or the eyelid height). For example, in various embodiments, measurements of eyes in a captured image may be used to determine vertical and horizontal eye gaze values mathematically or the measurements may be mapped to predetermined vertical and horizontal eye gaze values. In certain embodiments, the mapping may be determined, for example, during a training phase.

In certain embodiments, eye data is analyzed to control a device. For example, in some embodiments, eye movements may be mapped to one or more gestures that can cause a device to perform certain operations. In certain embodiments, eye movement may be determined by examining locations on a device focused on by a user derived from video or a set of photographs. For example, a selection gesture may be made if a user looks at an area on the device display for longer than a predetermined time or blinks while looking at an area on the device display. In some embodiments, an indicator may be displayed at a location associated with an eye gaze and/or movement so that the user can confirm that a correct selection will be made prior to making the selection. In addition, in some embodiments other facial movements may be used to make selections. For example, a selection may be made with respect to a location focused on by a user's eyes when a user makes a lip movement.

For example, in some embodiments, if it is determined that a user has made a selection gesture, such as by looking at an advertisement served to the user's device for more than a predetermined amount of time, the advertisement expands to a full-screen advertisement. As another example, a webpage that corresponds with the advertisement may be loaded in response to a selection gesture. As yet another example, a video that corresponds with the advertisement may be loaded in response to a selection gesture. In some embodiments, the type of eye movement required to make a selection gesture may be customized based on the advertisement. For example, the predetermined amount of time required to focus on an advertisement to make an eye movement representative of a selection gesture may be adjusted based on the type of advertisement. Of note, the initial advertisement may be selected based on a relevancy thereof to a user characteristic datum associated with the user.

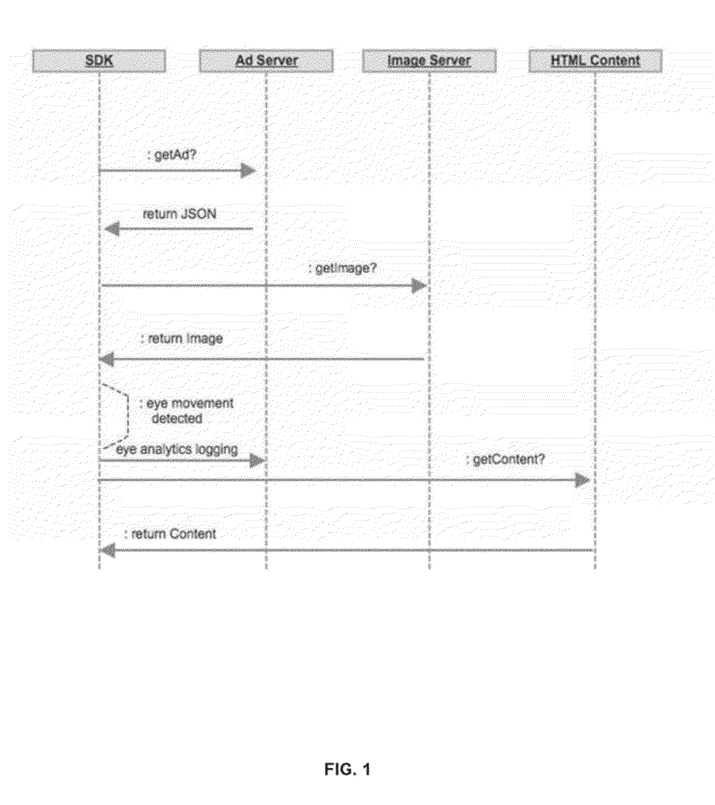

FIG. 1 depicts one example implementation for analyzing eye movement data. As depicted in FIG. 1, an embodiment may include a software development kit (SDK) that may execute on a device and that may request an advertisement from an ad server. In response to the advertisement request, in certain embodiments, the ad server may return JavaScript Object Notation (JSON) or HyperText Markup Language (HTML) data, and/or other data, that provides an indication of an image storage location. In response to the received JSON or HTML data, the SDK may then request an image from an image server. The image server may then return an image of an advertisement to the SDK for display on the device.

In some embodiments, the SDK may then detect eye gaze and/or movement associated with the displayed advertisement. For example, in the manner described above, the SDK may detect an advertisement selection based on an eye gaze and/or movement. In some embodiments, eye gaze and/or movement detection is performed locally on the device executing the SDK. In other embodiments, data from a front-facing camera of the device may be sent to a server to detect the eye gaze and/or movement associated with the displayed advertisement.

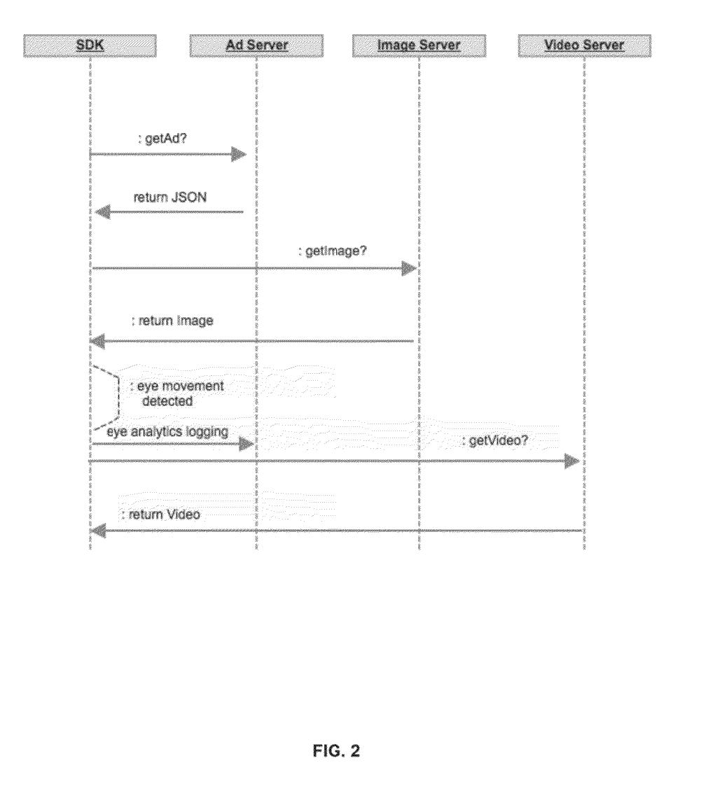

After detecting eye gaze and/or movement associated with the displayed advertisement, in certain embodiments, the SDK may request and receive content, such as HTML content (as depicted in FIG. 1) or video content (as depicted in FIG. 2). For example, the SDK may request and receive HTML content from an advertiser associated with the advertisement in response to a determination that a user has looked at an advertisement for longer than a predetermined amount of time. Additionally or alternatively, for example, the SDK may request and receive video associated with the advertisement in response to a determination that a user has looked at an advertisement for longer than a predetermined amount of time. In some embodiments, the Ad Server may also log data regarding the detected eye gaze and/or movement associated with the advertisement.

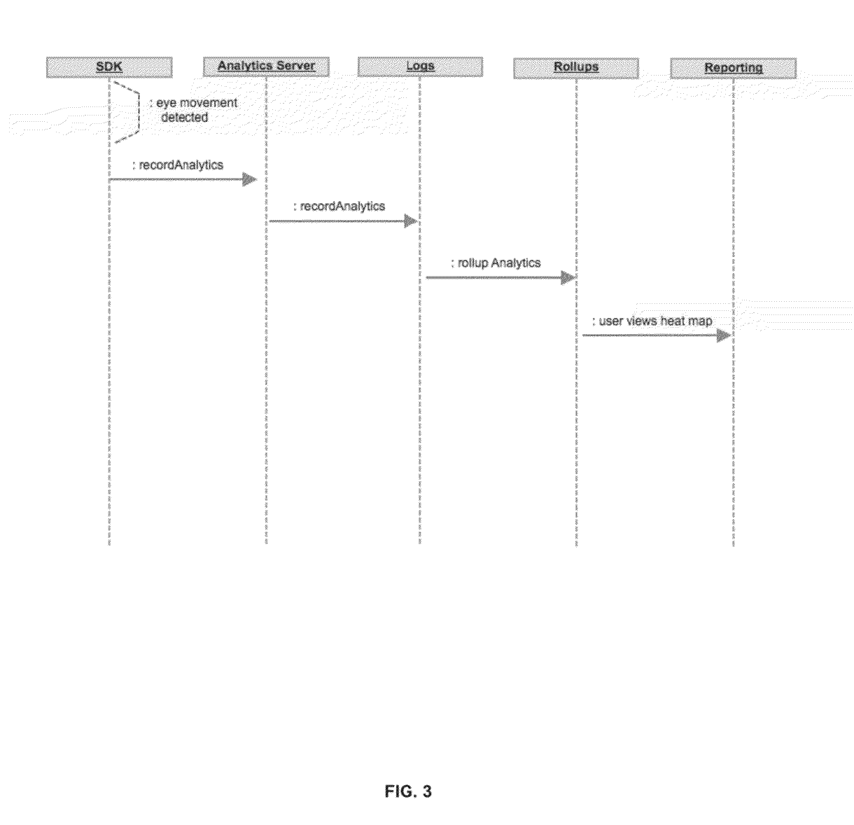

In certain embodiments, eye data is analyzed to derive information regarding an interaction with a device display. For example, as depicted in FIG. 3, an SDK may cause eye gaze and/or movement data to be recorded and sent to an analytics server. In some embodiments, the eye gaze and/or movement data may be temporarily maintained offline if, for example, an Internet connection is not available, and then sent to the analytics server. The data received by the analytics server may include data acquired, for example, as described above with respect to FIGS. 1 and 2. The data received by the analytics server may also or instead include other data, such as, for example, gesture and non-gesture eye gaze and/or movement data associated with a device display. For example, in some embodiments, the analytics server receives data representative of where a user is looking on a device at various times. In other embodiments, the analytics server receives data representative of where a user is looking when a gesture is made. Such eye gaze and/or movement data may be received from one or more SDKs and/or from one or more devices. Other data that may be received is actual content or contextual data representative of the content (e.g., web page text or image displayed or music or video played) that the user viewed while an advertisement was presented.

In some embodiments, the analytics server may log eye gaze and/or movement data and, in certain embodiments, other relevant data (e.g., time of image capture, location of the device at image capture, and/or demographic information of the user). For example, the analytics server may associate received eye gaze and/or movement data with respective SDKs that acquired the eye gaze and/or movement data or user profiles associated with the eye gaze and/or movement data. In some embodiments, eye gaze and/or movement data associated with, for example, one or more users of an application associated may be rolled up (i.e., aggregated) such that aggregate eye gaze and/or movement data is determined for the application. For example, the logged eye gaze and/or movement data may be aggregated to obtain data representative of the number of times eye gaze and/or movement data is associated with one or more locations of an application displayed on a device.

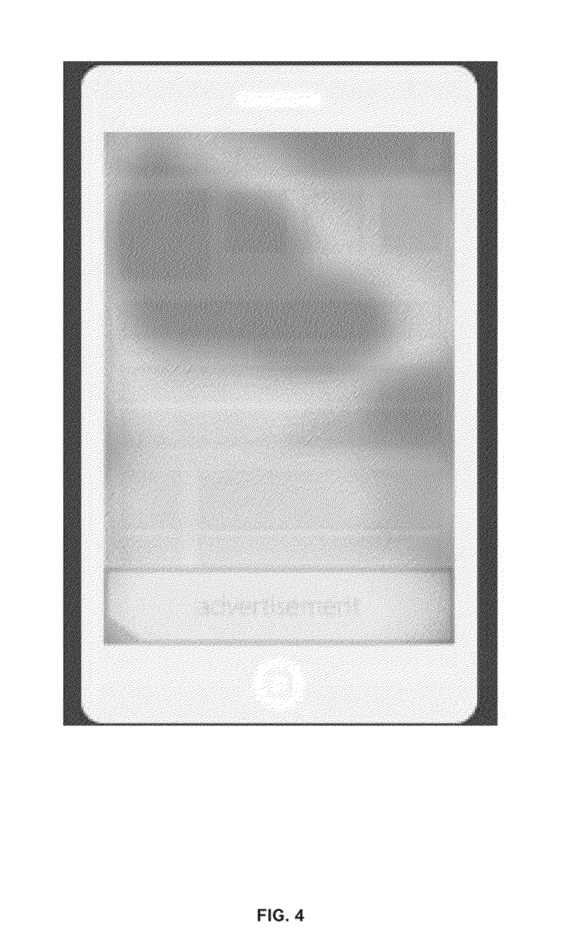

As depicted in FIG. 4, in some embodiments, a heat map may be generated based on the aggregate data. The heat map may provide an indication as to where, in the aggregate, one or more users are most often looking on a device display (e.g., the darker areas indicating a greater viewing than lighter areas). Such data can be correlated with data regarding what is displayed when the eye gaze and/or movement data used for generating the heat map is captured to provide an indication of content that the one or more users are drawn towards. For example, in an embodiment where a heat map is generated for an application, the location of various objects displayed on a device and data associated with the objects may be known or determined (e.g., data may be provided by a content provider, data may be determined by examining content, data may be determined using image or text recognition). For instance, objects of varying types (e.g., text, video, or image) and subject matters (e.g., clothing, sports, news, etc.) may be displayed on a device at known locations. Thus, for example, if a heat map is generated for an application that displays an image, among other content, the heat map may provide an indication of the relative frequency with which one or more users look at the particular type of content. Such data may be used to determine what advertisement to send to one or more user devices in response to future advertisement requests from an SDK. For example, in some embodiments, eye gaze and/or movement data may be used to categorize a user based on a determination that the user looks at content or advertisements associated with a particular category (e.g., a mother or a person interested in a particular brand). Such category data may be used to determine advertisements to send the user and/or advertisements not to send the user. In addition, in some embodiments, a plurality of heat maps may be generated for a user for a plurality of different advertisements, providing an indication of how often users are looking at a particular advertisement as compared to other advertisements. Such data may also be used to determine what advertisement from a set of advertisements to send to a user in the future.

In some embodiments, heat map data may also be used by, for example, content providers and advertisers for various purposes including improving content or advertisements. For example, a heat map may provide an indication of how often users are looking at a particular area or advertisement.

Eye-tracking may be used to place ads based on where a user has tendency to look on his mobile device (e.g., top, middle, bottom, right, left, etc.). This is targeting method designed to address a group of users exhibiting the same tendencies, or to target just one user. Users have ingrained behavior in their mobile viewing behavior. They do not look at certain parts of the mobile phone because advertisements are usually there. However, this system tracks where users are looking on a mobile phone, and then displays ads where users are looking on their screen. This can be done in two ways: 1) The system may track (in real-time or otherwise) where users look at the most on a mobile phone and displays advertisements there (e.g., use of the camera on the device to track/determine eye movement relative to the screen of the mobile device); 2) The system may also track gestures and movements on mobile phones that typically correspond to a user looking at a particular part of a mobile phone. Placements of advertisements are then changed based on where on the screen the system determines the user is looking. In mobile sites, commonly viewed areas used to navigate, drill down on images, or block text have high-view rates. The placement of these high-view rate areas can change as a user browses. Advertisements may be dynamically placed near these areas. In one example, in mobile applications, especially mobile games, users will view certain parts of the mobile phone in an effort to use the mobile application effectively. For instance, in order to play a certain game, a user will have to constantly look at a part of the mobile screen. The system dynamically changes the position of the ads based on where the high-view area is located. In addition, in some embodiments, for example, eye gaze and/or movement data can be analyzed to optimize advertisement delivery in other ways. For example, an advertisement may be delivered to a user based on where a user is looking at a particular time. For example, if it is determined that a user is looking at jeans (i.e., the area of the screen in which the particular product or other item appears), advertisements pertaining to jeans or clothes shopping may be delivered to the SDK to be then displayed on the screen either in connection with that product or in a retargeting scenario.

The techniques described in this specification, along with the associated embodiments, are presented for purposes of illustration only. They are not exhaustive and do not limit the techniques to the precise form disclosed. Thus, those skilled in the art will appreciate from this specification that modifications and variations are possible in light of the teachings herein or may be acquired from practicing the techniques.

Predicting Latent Conversions and Other Targeting Systems

A first system developed to overcome the deficiency in the prior art related to real-time bidding is known as bid landscaping. Bid landscaping is defined as comprehending a spectrum of bids within the real-time setting in order to optimize the most successful bid possible for the advertiser. Bid landscaping allows an advertising network to withhold a client's pricing and budget limitations. Bid landscaping also allows an advertiser to differentiate between PC-online and mobile spending.

A second system developed to overcome the deficiency in the prior art related to conversion tracking is known as projecting latent conversions. Projecting latent conversions is the ability to look out in time and understand conversions that continue after a first download or first conversion.

The projections of latent conversions may be assisted by clustering. Clustering by device is particularly relevant for projecting latent conversions. In clustering, all users in each dataset are used to generate clusters using a multi-attribute method. High level analysis of quality of the clusters is performed by calculating inter-cluster distances for all pairwise combinations of clusters, and intra-cluster distances & densities for each cluster by sampling. Clusters may be merged based on pairwise comparison of inter-cluster distances and pairwise comparison of user level correlations. All users in unmerged clusters are considered to look alike with higher probability of match than users in merged clusters. The attributes for the users in each cluster may be recommended to other users in the same cluster. In dataset merging, when merging datasets with some users being common between datasets, clusters are developed independently for each cluster. Users that are common users between datasets are identified. All clusters with common users are identified. Common users get the combined set—union of attributes from the corresponding datasets. The union of attributes is propagated to all users in the corresponding clusters in the merged datasets. The probability of match for the propagated data is lower than the union of attributes for common users. Users in clusters that do not have any users that are common between datasets are merged with the most closely correlated cluster. The propagation of attributes for these users has the least amount of confidence. Correlation of the same cluster with just the common users and all users is used to generate the probability value for the propagated users.

The system may also predict latent conversions in the mobile space only. The mobile predictions may patently differ from other latent conversion predictions. For example, a campaign launch system may offer a download to a mobile user. If the download is too big to transmit over a carrier network, and the download will not be able to complete until it connects to a WiFi setting. Latent conversion predictions may estimate which users and which devices will successfully later complete the download. This information may then be used to target these users and devices with similar and/or additional downloads at a later time (secondary conversions). Such predictions may also be used to target advertisements to these users and devices.

Such latent conversion predictions may also cluster not only by device, but by devices that have the same operating systems. These predictions may inform bidding algorithms and allow an audience/advertising platform to pick a reasonable price or bid for inventory when attempting to achieve a target CPA. Inventory may include network inventory and exchange inventory.

The system may also predict secondary conversions. Secondary conversions, simply, are conversions that occur after a successful first conversion, wherein the second conversion rides the coattails of the first conversion from a click, a download, a purchase, etc. Secondary conversions may be two conversions that result from a single click; from correlation identifications between a primary and secondary conversion; or may take place via two devices operated by the same user.

Secondary conversions may be based on an initial click of an advertisement, wherein the initial click acts as the first conversion. For example, an ad attracts a user, and the user clicks the ad (first conversion). The ad then redirects the user to landing page, wherein the user purchases a product or service (second conversion).

The secondary conversion may not occur immediately. For example, the user may click the ad on Monday, and then purchase the product or service on Thursday. A correlation ID between primary and secondary conversions links the two conversions, and may be used to predict other users' probability of a second conversion. Therefore, correlation IDs may be used to target ads to achieve the second conversion, or any additional conversions.

As a single user may access the Internet from multiple devices (better known as “cross screen”), an audience/advertising platform wants to identify the same user across wired web, mobile web, and mobile application traffic. Cross-screen analysis applies to correlation IDs, as the secondary conversion may occur by the same user, but on a different device than the one on which he initially clicked the ad. Therefore, an audience/advertising platform may target the user on various devices, upon identifying him, to achieve the secondary conversion.

Cost-per-acquisition optimization merges latent conversion predictions, targeting, engaging specific properties of a device. It may involve multiple dimensions, including creative optimization, and opens up dynamic real-time bidding in the mobile space.

Dynamic real-time bidding operates by an audience/advertising platform receiving a real-time bid request for a particular site. The platform already knows certain a third party yields better results than another third party.

Consideration intent predicts a conversion in a user's thinking, and therefore, is useful in targeting advertisements. Consideration intent integrates Polk context, third party data, behavioral data, and retargeting data. It measures whether a user is in a consideration frame of mind For example, auto-intender data identifies a user who typically purchases new cars from Acura. The typical Acura buyer is identified as not being in the market for a new vehicle, but looking at various auto sites, so a variety of auto advertisements is delivered to the user. A data system pixel-tags sites such as Auto-Trader and Kelly Blue Book to record any new makes of cars the user researches. Consideration intent determines how serious the lifetime Acura buyer is about purchasing a different make of vehicle.

Should the Acura buyer purchase a different make, the purchase is a permanent data record. It is not information that expires, like cookie-based data. Permanent data may be used to target the user indefinitely.

Another system developed to predict latent conversions uses addressable televisions. Addressable televisions provide access to advertisement retargeting, sequencing, attribution via television to an audience. Addressable televisions correlate what a user is watching while simultaneously using his phone or mobile device.

Traditionally, television and radio signals are broadcasted with no ability to discriminate target audiences. The system herein allows advertisers to target audience members in a ubiquitous manner. Advertisers use audience characteristics gathered through a variety of data sources and target specific members or groups through a variety of mediums including, but not limited to: televisions, radios, computers, phones, and even physical mail.

Integrated receivers and decoders or IP devices connected to a television receive from and send to broadcasters' information about a person's television viewing behaviors. These behaviors include which television shows the person is watching, when channels are changed, and whether the television is on or off Advertisers combine a viewer's behavioral characteristics with other characteristics about the viewer, such as demographic, preferences, shopping behavior, and location, to determine which advertisement to show the user. Advertisers then send different ads to different people through the integrated receiver and decoder or IP device.

Integrated receivers and decoders or IP devices connected to radios, computers, and phones play a similar function. Advertisers combine a user's behavior on radio, computer, and phone with other audience characteristics to determine which advertisement to show the user. Advertisers then send different ads to different people through the integrated receivers and decoders or IP device.

Once a person has seen or heard an advertisement through one of the mediums (i.e., television, radio, computer, phone, or physical mail), then the advertiser retargets the person by sending related advertisements to the person on other mediums. For example, once the person has seen commercial A on television, then the person is sent a related commercial A′ through the computer, phone, radio, or physical mail.

The advertiser also sends related advertisements based on the time of day, whether the advertisement has been viewed or heard, and whether the person has engaged with the advertisement (i.e., clicked on the advertisement on a website, mobile site, or mobile application).

Targeting users in this manner increases the effectiveness of an advertisement because the user is reminded of an advertisement's message across several mediums. Advertisers can also break up an advertisement across several different mediums, presenting different aspects of the advertisement based on the medium.

Users can also engage with the surrounding advertisements on the mobile phone (e.g., manipulate a car on a mobile phone ad) and advertisements will dynamically change on the television (e.g., car commercial on television moves based on car's movements on phone) or on the radio (e.g., car noises change based on the car's movements on the phone).

Another system developed to overcome a deficiency in the prior art is short-term identification (“ID”) linking. Validation may be required when the frequency of an ID appears. For example, when a given ID from a hashed email appears together with another ID from a new device, there is a minimum threshold of appearances the two IDs must make in order to indicate the user is the same user each time. In one embodiment the minimum threshold is seeing the two IDs three times. The IDs must be seen with other valid IDs, and a group of IDs indicating the same user becomes known as a family of IDs. The short-term aspect provides for the IDs expiring within minutes or hours, recognizing that mobile devices are not always used by the same user. Therefore, an audience/advertising platform can target the user appropriately, even when not using her own device.

Because multiple IDs can exist on a single device, the platform may also exhibit a system to know when to validate and when to invalidate IDs, and may also exist in the short-term.

Another system developed to overcome a deficiency in the prior art is focused on in-home mobile use. In-home mobile device use continues to grow. Users exhibit different behaviors when home as opposed to outside of the home, and even may exhibit different behaviors in different rooms of the home.

In-home mobile device use can expand to other appliances in a home. For example, a mobile phone may interact with a refrigerator via WiFi. Before, users had no way to communicate with traditional appliances unless they physically press buttons on the appliance. The system provides a solution where phones may communicate with appliances imbedded with computers. Communication includes user's grocery shopping behavior (i.e. refrigerator), eating habits of certain foods (i.e. microwave), and cooking behavior (i.e. stove). Advertisers can take this information to provide more targeted advertising on mobile phones and the appliances themselves. Phones can also communicate with appliances with imbedded computers to turn them on or off and can also get automated maintenance updates from the appliance manufacturers.

In-home mobile use may also be a relevant factor in prediction latent conversions. Tracking such data overcomes the prior art that discloses day-parting, which is the only way a PC-online system can track such user behavior.

In-home mobile use may be communicated by Internet Protocol version 6 (IPv6), which is the latest revision of the Internet Protocol (IP), the communications protocol that routes traffic across the Internet. It is intended to replace IPv4, which still carries the vast majority of Internet traffic as of 2013. Every device on the Internet, such as a computer or mobile telephone, must be assigned an IP address for identification and location addressing in order to communicate with other devices. With the ever-increasing number of new devices being connected to the Internet, the need arose for more addresses than IPv4 is able to accommodate. IPv6 uses a 128-bit address, allowing for 2¹²⁸, or approximately 3.4×10³⁸ addresses, or more than 7.9×10²⁸ times as many as IPv4, which uses 32-bit addresses. IPv4 allows for only approximately 4.3 billion addresses. The two protocols are not designed to be interoperable, complicating the transition to IPv6. IPv6 addresses consist of eight groups of four hexadecimal digits separated by colons,

Other targeting methods include free-form advertisements, where advertisements are inserted into paragraph breaks. Advertisements are not relegated to the top or bottom of the screen. This provides a viewable impression within a page or application.

Refreshing the page traditionally indicates a request for a new advertisement. Dynamic page manipulation, however, refreshes a page automatically, not manually. It may dynamically modify the position of an advertisement. An aura may provide dynamic data attributes to feed back for subsequent retargeting.

Contextual, Publisher, and Advertiser Classifications

Contextual classification of mobile websites and applications in absence of sufficient data assists in more accurately targeting a user, and therefore in accurately predicting latent conversions. Publisher and advertiser classification have similarly developed algorithms, and therefore may assist in targeting and conversion predictions.

Mobile data differs greatly from PC-online webpages. The webpages or applications provide a lot less data that can be used contextually. The pages are dynamic, and may consist of links to pages with limited to no contextual information in the links. When directed to the webpage, the mobile version of the webpage may have limited text that may not provide sufficient statistics for contextual analysis. To overcome this obstacle, a system exists to map the links observed from the mobile site to the web version of the same site (if there is one), and extracts the contextual statistics for the page. This method assists in boosting mobile page statistics. For cases where there are no corresponding non-mobile sites, a content taxonomy has been developed that can predict the most probable class for the page with the limited information present on the mobile page.

One core requirement in performing behavior targeting is to get the classification of ads, publishers and users correct. The publishers are the suppliers of inventory; these include web sites and applications, for example. The problem of classifying publishers into their contextual categories is now addressed so that an advertising/audience platform can most accurately target its audiences.

Classification methodology overview operates in the following steps:

1. Work with publishers to send any reliable information such as referrer URL, current URL, page category, user information such as demographics and if they have known interests.

2. For applications, work with application developers, publishers, supply-side platforms, and aggregators to provide application name to the audience platform. This may require changes on their end to their software development kit (“SDK”) with which application developers integrate.

3. Add a requirement to the audience platform SDK to require application developers to provide app name.

4. Develop an algorithm to crawl websites and app stores and classify inventory into categories.

4a. Analyze and cross-validate classes and fine tuning the results to reduce any human intervention.

4b. Validate using human interpretation.

4c. Internally validate with pub ops which categories are sellable.

The problem in publisher classification is referring to websites and applications as the publishers. First, there is a need to define the contextual categories into which the publishers are classified. The candidate publishers to be classified are received in the URL received on the advertisement request. The classification must occur for the page on which the advertisement will be displayed at the advertisement-spot level. The algorithm developed should be capable of classification at as granular a level as possible. It must be robust to roll up to another level, should data is insufficient at the lower level.

The methodology of distinguishing publisher classification is as follows: use the tier-1 IAB categories as the basis for generating publisher categories. Once the categories are defined, the web pages and applications are segregated into the defined categories. Classification involves a training phase and a testing phase.

The training phase requires seeding the learning algorithm with data that is manually classified. Once the classification algorithm is trained, the algorithm expands to testing data. This data needs to be classified. In the testing phase, the web pages and the applications that are viewed on the advertising/audience platform are classified. A random sample of results will be tested for accuracy.

Next is the problem in class or category definition. The first step in the process of classification is to generate a list of categories into which the publishers will be placed. The list includes primary categories, e.g., contextual categories. In this research, composite categories (categories that can be created by combining two primary categories or external data, like “soccer moms”) may not be created.

The category definitions begin by using the IAB tier-1 categories, using the category names as the search keyword. For each category, the top 25 relevant sites are manually selected. The system runs a crawler through each one of the sites and extracts the following: keywords, description, title, and body text. It then parses the URL to extract the base URL of the main page of the site.

The system removes common words by setting a ‘stop words’ list. From the remaining words, it generates a word count for each category by considering words from all sites in the category together. The words are then ranked in the descending order of their word count, and generic words that describe the contents of the category are redirected into tier-2 categories. Only words that have a word count of at least 10% of the top keyword are considered.

The system generates subcategories for the tier-2 categories only based on requirements or third party data. The system also has the capability to build deeper subcategories by using current or past advertiser campaign targeting criteria.

For URL analysis, the system crawls the website, and parses the URLs. URLs may be parsed only to the base site level. For example, consider the following link: http://www.foxnews.com/politics/2012/01/03/in-anybodys-game-candidates-count-on-iowa-voters-to-surprise-nation/. When it extracts the link, it will parse only the main page which is http://www.foxnews.com.

The goal is to classify the page into tier-1 or tier-2 categories. Tier-2 category will be in a level lower than the base URL, which is http://www.foxnews.com/politics, in this case. The system may trace back such relationships between various levels of pages through their contextual connections. The intent is to build a tree with an escalation logic, which can have multiple branches leading to one top level category.

The above link is a particular article on Fox News; it is a dynamic link. It is necessary to separate links that refer to the category instead of links that redirect to the content of the link. Since every site has different styles for generating the page content, a system must use data rather than rely on the crawler, which will pull all the links and their content based on the tags in the page source.

The source for each page contains links some of these links are for dynamic pages, while others are for categories of the pages. The system must extract the categories of the content, and ignore the links for the dynamic content. It scans the description, keywords, title, and the content of the page to establish the context and the categories of the page. Then the system counts the number of times a certain class name has been used in a particular category of site. It ranks the classes in the descending order and manually chooses the classes. The system operates via the following steps:

1. Use the IAB Tier 1 categories

2. Use Web-Spider [1] to generate a list of top 25 sites for each one of the tier 1 IAB categories. Generate separate lists for composite categories. For example, for arts & entertainment, generate list of sites separately for arts and entertainment, respectively.

3. Crawl these sites and extract the URL, keywords, description, the title of the site and the body of text.

3a. To reduce the URLs pulled up for dynamic web pages, if the URL contains more than four words in the URL discard the URL. NOTE: If we know of cases where this rule might remove valid URLs, then set exceptions.

4. Parse out the URLs, keywords, descriptions and the title to generate a bag of words.

5. Generate a list of stop words which need to be ignored.

6. For each tier 1 IAB category, calculate the word count.

7. For each category, rank words in the descending order of the count.

8. Delete all words that have a word count that is less than 10% of the max word count in the category.

9. Manually pick classes from the ranked list, by ignoring non-generic words.

To target most accurately, an advertising/audience platform will rely on such classifications. The training set for classification will be the same set of the sites that were chosen for performing taxonomy. All keywords with a word count less than 10% of the max count are added to an “ignore” list. This generally takes care of proper nouns in the text.

To target most accurately, an advertising/audience platform will rely on contextual analysis. Websites may be categorized based on the content in pages. Applications have predefined classifications, which are used by the application stores to differentiate applications. Classification may be very specific or very generic. For example, a careers application may be classified as “utility.” The system needs to understand the specific context of the application so that it can categorize it correctly within a given advertising/audience platform's taxonomy. Websites and applications, as they operate differently, need different methods.

Web pages: The home page of many websites does not contain much information in form of body of text that might provide information about the website. They generally have a many URLs pointing to other pages. Where there is body of text, much of it is in the form of summaries of the URLs on the page. For example, websites of companies that are selling products or services may have some information about the company or may be mistaken for a shopping website. If the URL the system receives gives points to an aggregator or a supply side partner, the system may record this information. Since indicates an issue with integration with a partner and would require correction so that it can record the correct URL of the site the user is visiting.

Websites need a hierarchical method. For example, if a user goes to a news site, he finds a long list of links to news articles. Just using the text in the links may result in an inaccurate classification of the site. However, even if the only link the system receives is the top level home page link, it may crawl to the second level. It may then record more analysis, giving better results, since it finds more available data. Any URL which is not at the top level will be parsed out to the top level before it is classified (as described in the category creation section, above). Where not enough data exists on a mobile web site, the system will crawl to the regular wired website. Sites identified by ‘In’, ‘mobile’ or ‘.mobi’ can be converted into the wired version and used for classification since it provides more data about the site.

Some websites have containers in which the page source is available for that particular container, thus causing erroneous classification. In some other cases, it may not be easy or possible to crawl the page. In most cases, such behavior is observed from the mobile version of the site; using the wired version might alleviate this problem.

For any URL received, whether current or referrer, the system must run the classification algorithm twice; once for the base URL and once for the complete URL.

Tier 2 classification is reliant on other tiers' data. Only if there is requirement for specific tier 2 classes will the system develop the detail for hierarchical escalation logic.

Applications and application stores have their own categories. The category is described directly on the page, and may be used to simplify the classification process. However, the system must extract other keywords from the application store's web page for the application. This confirms that the category is the same as the description. The procedure is not very different from the website contextual classification. However, the system may use the context to develop tier 3 classes for applications.

To appropriately categorize, the system uses category scoring. To identify category scores, the system must understand user behavior of categories. Note, that here it develops the distribution of category's behavior, and not individual user behavior. The individual user behavior analysis will be performed while performing user identification. To score categories, the system needs to understand the distribution of the traffic based on user information, location, time of day, day of the week and comparison to other categories while everything else is kept constant.

[symbol]

Notation
cᵢ→Average cost to pay for inventory i over time t
vᵢ→Revenue share percent with publisher

rᵢ→through rate advertiser j on impression i
nᵢ→The number of requests received from inventory i
φᵢ→Fill rate of inventory i

Methodology: The metrics that can define the performance of a publisher are request volume, fill rate, CTR, CPA, average bid price. The steps must be performed for each attribute separately for a predetermined time period.

To rank publisher inventory, generate for each publisher the distribution and the attribute and calculate the mean and standard deviation. The objective function for rank calculation will be expected revenue over a period of time.

$$\begin{matrix}Expected revenue from a site = h \text{?} \\ = \text{?} \cdot \text{?} \cdot \text{?} \cdot \text{?} \cdot ( 1 - \text{?} )\end{matrix}$$

$$\text{?} \text{indicates text missing or illegible when filed}$$

Calculate the percentile rank of each publisher for h(l)
l→number of scores less than the current score
fₛ→frequency of the score s
N→number of data points in the sample

$$\text{?} -> percentile rank$$

$$\text{?} \text{indicates text missing or illegible when filed}$$

The ranked publishers may be segmented into any number of categories based on the desired level of granularity of segments of performance. If there is a cost c(l) calculated to place ads on publisher for inventory l, and h(l)≦c(l) then those publishers may be removed from the inventory list. However, these could be lower in the rank and might get discarded anyway.

To implement and maintain the architecture of this system, publisher URLs with corresponding categories should be maintained in memory. URL-based traffic rules for special ad selection or exclusion may be used. A flag will designate publishers that are ideal for being advertisers as well.

The URL received in the request needs to be checked if it has a category assigned to it already or if there are other rules such as content that should not be advertised. For exclusion rules, the system does not have to be at the level of the current user URL. It can extract the base URL to generate exclusion rules.

If no user information is available, but the URL is of a publisher where the system can provide a default advertisement which does not require any targeting, then the advertisement can be directly delivered. It bypasses part of the algorithmic process, thus providing more bandwidth to process more requests.

As previously mentioned, the system uses a validation step. It validates using human interpretation of classified publishers. It may also internally validate.

As previously mentioned, the system uses crawler technology. It may crawl publishers in which it is interested look at advertisers on these sites. The advertising/audience platform may contact those advertisers as potential clients. The systems described above may also be used to classify advertisers identify advertisers from certain categories in which the platform is interested.

Advertiser classification may use landing pages of advertisers to categorize them into categories. It may incorporate content characteristics, online media rating system, non-standard content, and illegal content. Note these checks need to be performed for publishers too. The system may identify publishers as well as advertisers which have content that may not be acceptable for all publishers and/or advertisers.

The advertising/audience platform may also explore potential publisher partnership, as the system automatically seeds the publishers for any given keyword or category.

The methods and systems described herein may be deployed in part or in whole through a machine that executes computer software program codes, and/or instructions on one or more processors. The one or more processors may be part of a server, client, network infrastructure, mobile computing platform, stationary computing platform, cloud computing, or other computing platform. The processor(s) may be communicatively connected to the Internet or any other distributed communications network via a wired or wireless interface. The processor(s) may be any kind of computational or processing device capable of executing program instructions, codes, binary instructions and the like. The processor(s) may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor(s) may enable execution of multiple programs, threads, and codes. The threads may be executed simultaneously to enhance the performance of the processor(s) and to facilitate simultaneous operations of the application. The processor(s) may include memory that stores methods, codes, instructions and programs as described herein and elsewhere. The processor(s) may access a storage medium through an interface that may store methods, codes, and instructions as described herein and elsewhere. The storage medium associated with the processor(s) for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object-oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

Further, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media. When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article. The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G, LTE, WiMax. A non-transitory computer-readable medium includes all computer-readable medium as is currently known or will be known in the art, including register memory, processor cache, and RAM (and all iterations and variants thereof), with the sole exception being a transitory, propagating signal.

Where databases are described, it will be understood by one of ordinary skill in the art that (i) alternative database structures to those described may be readily employed, and (ii) other memory structures besides databases may be readily employed. Any schematic illustrations and accompanying descriptions of any sample databases presented herein are illustrative arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, other formats (including relational databases, object-based models and/or distributed databases) could be used to store and manipulate the data types described herein. Likewise, object methods or behaviors of a database can be used to implement the processes of the present invention. In addition, the described databases may, in a known manner, be stored locally or remotely from a device that accesses data in such a database.

Numerous embodiments are described in this patent application, and are presented for illustrative purposes only. The described embodiments are not intended to be limiting in any sense. The invention is widely applicable to numerous embodiments, as is readily apparent from the disclosure herein. Those skilled in the art will recognize that the present invention may be practiced with various modifications and alterations. Although particular features of the present invention may be described with reference to one or more particular embodiments or figures, it should be understood that such features are not limited to usage in the one or more particular embodiments or figures with reference to which they are described.

In the foregoing description, reference is made to the accompanying drawings that form a part of the present disclosure, and in which are shown, by way of illustration, specific embodiments of the invention. These embodiments are described in sufficient detail to enable those skilled in the art to practice the invention, and it is to be understood that other embodiments may be utilized and that structural, logical, software, electrical and other changes may be made without departing from the scope of the present invention. The present disclosure is, therefore, not to be taken in a limiting sense. The present disclosure is neither a literal description of all embodiments of the invention nor a listing of features of the invention that must be present in all embodiments.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment. Those skilled in the art will appreciate from this specification that modifications and variations are possible in light of the teachings herein or may be acquired from practicing the techniques.

This application incorporates herein by reference the content of each of the following applications: U.S. Provisional Pat. App. No. 61/558,522 filed Nov. 11, 2011, and titled “Targeted Advertising Across a Plurality of Mobile and Non-Mobile Communication Facilities Accessed By the Same User,” U.S. Provisional Pat. App. No. 61/569,217 filed Dec. 9, 2011, and titled “Targeted Advertising Across Web Activities On an MCF and Applications Operating Thereon,” U.S. Provisional Pat. App. No. 61/576,963 filed Dec. 16, 2011, and titled “Targeted Advertising to Mobile Communication Facilities,” and U.S. Provisional Pat. App. No. 61/652,834 filed May 29, 2012, and titled “Validity of Data for Targeting Advertising Across a Plurality of Mobile and Non-Mobile Communication Facilities Accessed By the Same User.”

This application also incorporates herein by reference the content of each of the following applications: U.S. application Ser. No. 13/666,690, filed on Nov. 1, 2012 and entitled “Identifying a Same User of Multiple Communication Devices Based on Web Page Visits”; and U.S. application Ser. No. 13/667,515 filed on Nov. 2, 2012 and entitled “Validation of Data for Targeting Users Across Multiple Communication Devices Accessed By the Same User”; U.S. application Ser. No. 13/668,300, filed on Nov. 4, 2012 and entitled “System For Determining Interests of Users of Mobile and Non-Mobile Communication Devices Based on Data Received From a Plurality of Data Providers;” and U.S. application Ser. No. 13/018,952 filed on Feb. 1, 2011, which is a non-provisional of App. No. 61/300,333 filed on Feb. 1, 2010 and entitled “INTEGRATED ADVERTISING SYSTEM,” and which is a continuation-in-part of U.S. application Ser. No. 12/537,814 filed on Aug. 7, 2009 and entitled “CONTEXTUAL TARGETING OF CONTENT USING A MONETIZATION PLATFORM,” which is a continuation of U.S. application Ser. No. 12/486,502 filed on Jun. 17, 2009 and entitled “USING MOBILE COMMUNICATION FACILITY DEVICE DATA WITHIN A MONETIZATION PLATFORM,” which is a continuation of U.S. application Ser. No. 12/485,787 filed on Jun. 16, 2009 and entitled “MANAGEMENT OF MULTIPLE ADVERTISING INVENTORIES USING A MONETIZATION PLATFORM,” which is a continuation of U.S. application Ser. No. 12/400,199 filed on Mar. 9, 2009 and entitled “USING MOBILE APPLICATION DATA WITHIN A MONETIZATION PLATFORM,” which is a continuation of U.S. application Ser. No. 12/400,185 filed on Mar. 9, 2009 and entitled “REVENUE MODELS ASSOCIATED WITH SYNDICATION OF A BEHAVIORAL PROFILE USING A MONETIZATION PLATFORM,” which is a continuation of U.S. application Ser. No. 12/400,166 filed on Mar. 9, 2009 and entitled “SYNDICATION OF A BEHAVIORAL PROFILE USING A MONETIZATION PLATFORM,” which is a continuation of U.S. application Ser. No. 12/400,153 filed on Mar. 9, 2009 and entitled “SYNDICATION OF A BEHAVIORAL PROFILE ASSOCIATED WITH AN AVAILABILITY CONDITION USING A MONETIZATION PLATFORM,” which is a continuation of U.S. application Ser. No. 12/400,138 filed on Mar. 9, 2009 and entitled “AGGREGATION AND ENRICHMENT OF BEHAVIORAL PROFILE DATA USING A MONETIZATION PLATFORM,” which is a continuation of U.S. application Ser. No. 12/400,096 filed on Mar. 9, 2009 and entitled “AGGREGATION OF BEHAVIORAL PROFILE DATA USING A MONETIZATION PLATFORM,” which is a non-provisional of App. No. 61/052,024 filed on May 9, 2008 and entitled “MONETIZATION PLATFORM” and App. No. 61/037,617 filed on Mar. 18, 2008 and entitled “PRESENTING CONTENT TO A MOBILE COMMUNICATION FACILITY BASED ON CONTEXTUAL AND BEHAVIORIAL DATA RELATING TO A PORTION OF A MOBILE CONTENT,” and which is a continuation-in-part of U.S. application Ser. No. 11/929,328 filed on Oct. 30, 2007 and entitled “CATEGORIZATION OF A MOBILE USER PROFILE BASED ON BROWSE BEHAVIOR,” which is a continuation-in-part of U.S. application Ser. No. 11/929,308 filed on Oct. 30, 2007 and entitled “MOBILE DYNAMIC ADVERTISEMENT CREATION AND PLACEMENT,” which is a continuation-in-part of U.S. App. No. U.S. application Ser. No. 11/929,297 filed on Oct. 30, 2007 and entitled “MOBILE COMMUNICATION FACILITY USAGE AND SOCIAL NETWORK CREATION”, which is a continuation-in-part of U.S. application Ser. No. 11/929,272 filed on Oct. 30, 2007 and entitled “INTEGRATING SUBSCRIPTION CONTENT INTO MOBILE SEARCH RESULTS,” which is a continuation-in-part of U.S. application Ser. No. 11/929,253 filed on Oct. 30, 2007 and entitled “COMBINING MOBILE AND TRANSCODED CONTENT IN A MOBILE SEARCH RESULT,” which is a continuation-in-part of U.S. application Ser. No. 11/929,171 filed on Oct. 30, 2007 and entitled “ASSOCIATING MOBILE AND NONMOBILE WEB CONTENT,” which is a continuation-in-part of U.S. application Ser. No. 11/929,148 filed on Oct. 30, 2007 and entitled “METHODS AND SYSTEMS OF MOBILE QUERY CLASSIFICATION,” which is a continuation-in-part of U.S. application Ser. No. 11/929,129 filed on Oct. 30, 2007 and entitled “MOBILE USER PROFILE CREATION BASED ON USER BROWSE BEHAVIORS,” which is a continuation-in-part of U.S. application Ser. No. 11/929,105 filed on Oct. 30, 2007 and entitled “METHODS AND SYSTEMS OF MOBILE DYNAMIC CONTENT PRESENTATION,” which is a continuation-in-part of U.S. application Ser. No. 11/929,096 filed on Oct. 30, 2007 and entitled “METHODS AND SYSTEMS FOR MOBILE COUPON TRACKING,” which is a continuation-in-part of U.S. application Ser. No. 11/929,081 filed on Oct. 30, 2007 and entitled “REALTIME SURVEYING WITHIN MOBILE SPONSORED CONTENT,” which is a continuation-in-part of U.S. application Ser. No. 11/929,059 filed on Oct. 30, 2007 and entitled “METHODS AND SYSTEMS FOR MOBILE COUPON PLACEMENT,” which is a continuation-in-part of U.S. application Ser. No. 11/929,039 filed on Oct. 30, 2007 and entitled “USING A MOBILE COMMUNICATION FACILITY FOR OFFLINE AD SEARCHING,” which is a continuation-in-part of U.S. application Ser. No. 11/929,016 filed on Oct. 30, 2007 and entitled “LOCATION BASED MOBILE SHOPPING AFFINITY PROGRAM,” which is a continuation-in-part of U.S. application Ser. No. 11/928,990 filed on Oct. 30, 2007 and entitled “INTERACTIVE MOBILE ADVERTISEMENT BANNERS,” which is a continuation-in-part of U.S. application Ser. No. 11/928,960 filed on Oct. 30, 2007 and entitled “IDLE SCREEN ADVERTISING,” which is a continuation-in-part of U.S. application Ser. No. 11/928,937 filed on Oct. 30, 2007 and entitled “EXCLUSIVITY BIDDING FOR MOBILE SPONSORED CONTENT,” which is a continuation-in-part of U.S. application Ser. No. 11/928,909 filed on Oct. 30, 2007 and entitled “EMBEDDING A NONSPONSORED MOBILE CONTENT WITHIN A SPONSORED MOBILE CONTENT,” which is a continuation-in-part of U.S. application Ser. No. 11/928,877 filed on Oct. 30, 2007 and entitled “USING WIRELESS CARRIER DATA TO INFLUENCE MOBILE SEARCH RESULTS,” which is a continuation-in-part of U.S. application Ser. No. 11/928,847 filed on Oct. 30, 2007 and entitled “SIMILARITY BASED LOCATION MAPPING OF MOBILE COMMUNICATION FACILITY USERS,” which is a continuation-in-part of U.S. application Ser. No. 11/928,819 filed on Oct. 30, 2007 and entitled “TARGETING MOBILE SPONSORED CONTENT WITHIN A SOCIAL NETWORK,” which is a non-provisional of U.S. App. No. 60/946,132 filed on Jun. 25, 2007 and entitled “BUSINESS STREAM: EXPLORING NEW ADVERTISING OPPORTUNITIES AND AD FORMATS,” and U.S. App. No. 60/968,188 filed on Aug. 27, 2007 and entitled “MOBILE CONTENT SEARCH” and a continuation-in-part of U.S. application Ser. No. 11/553,746 filed on Oct. 27, 2006 and entitled “COMBINED ALGORITHMIC AND EDITORIAL-REVIEWED MOBILE CONTENT SEARCH RESULTS,” which is a continuation of U.S. application Ser. No. 11/553,713 filed on Oct. 27, 2006 and entitled “ON-OFF HANDSET SEARCH BOX,” which is a continuation of U.S. application Ser. No. 11/553,659 filed on Oct. 27, 2006 and entitled “CLIENT LIBRARIES FOR MOBILE CONTENT,” which is a continuation of U.S. application Ser. No. 11/553,569 filed on Oct. 27, 2006 and entitled “ACTION FUNCTIONALITY FOR MOBILE CONTENT SEARCH RESULTS,” which is a continuation of U.S. application Ser. No. 11/553,626 filed on Oct. 27, 2006 and entitled “MOBILE WEBSITE ANALYZER,” which is a continuation of U.S. application Ser. No. 11/553,598 filed on Oct. 27, 2006 and entitled “MOBILE PAY PER CALL,” which is a continuation of U.S. application Ser. No. 11/553,587 filed on Oct. 27, 2006 and entitled “MOBILE CONTENT CROSS-INVENTORY YIELD OPTIMIZATION,” which is a continuation of U.S. application Ser. No. 11/553,581 filed on Oct. 27, 2006 and entitled “MOBILE PAYMENT FACILITATION,” which is a continuation of U.S. application Ser. No. 11/553,578 filed on Oct. 27, 2006 and entitled “BEHAVIORAL-BASED MOBILE CONTENT PLACEMENT ON A MOBILE COMMUNICATION FACILITY,” which is a continuation application of U.S. application Ser. No. 11/553,567 filed on Oct. 27, 2006 and entitled “CONTEXTUAL MOBILE CONTENT PLACEMENT ON A MOBILE COMMUNICATION FACILITY”, which is a continuation-in-part of U.S. application Ser. No. 11/422,797 filed on Jun. 7, 2006 and entitled “PREDICTIVE TEXT COMPLETION FOR A MOBILE COMMUNICATION FACILITY”, which is a continuation-in-part of U.S. application Ser. No. 11/383,236 filed on May 15, 2006 and entitled “LOCATION BASED PRESENTATION OF MOBILE CONTENT”, which is a continuation-in-part of U.S. application Ser. No. 11/382,696 filed on May 10, 2006 and entitled “MOBILE SEARCH SERVICES RELATED TO DIRECT IDENTIFIERS”, which is a continuation-in-part of U.S. application Ser. No. 11/382,262 filed on May 8, 2006 and entitled “INCREASING MOBILE INTERACTIVITY”, which is a continuation of U.S. application Ser. No. 11/382,260 filed on May 8, 2006 and entitled “AUTHORIZED MOBILE CONTENT SEARCH RESULTS”, which is a continuation of U.S. application Ser. No. 11/382,257 filed on May 8, 2006 and entitled “MOBILE SEARCH SUGGESTIONS”, which is a continuation of U.S. application Ser. No. 11/382,249 filed on May 8, 2006 and entitled “MOBILE PAY-PER-CALL CAMPAIGN CREATION”, which is a continuation of U.S. application Ser. No. 11/382,246 filed on May 8, 2006 and entitled “CREATION OF A MOBILE SEARCH SUGGESTION DICTIONARY”, which is a continuation of U.S. application Ser. No. 11/382,243 filed on May 8, 2006 and entitled “MOBILE CONTENT SPIDERING AND COMPATIBILITY DETERMINATION”, which is a continuation of U.S. application Ser. No. 11/382,237 filed on May 8, 2006 and entitled “IMPLICIT SEARCHING FOR MOBILE CONTENT,” which is a continuation of U.S. application Ser. No. 11/382,226 filed on May 8, 2006 and entitled “MOBILE SEARCH SUBSTRING QUERY COMPLETION”, which is a continuation-in-part of U.S. application Ser. No. 11/414,740 filed on Apr. 27, 2006 and entitled “EXPECTED VALUE AND PRIORITIZATION OF MOBILE CONTENT,” which is a continuation of U.S. application Ser. No. 11/414,168 filed on Apr. 27, 2006 and entitled “DYNAMIC BIDDING AND EXPECTED VALUE,” which is a continuation of U.S. application Ser. No. 11/413,273 filed on Apr. 27, 2006 and entitled “CALCULATION AND PRESENTATION OF MOBILE CONTENT EXPECTED VALUE,” which is a non-provisional of U.S. App. No. 60/785,242 filed on Mar. 22, 2006 and entitled “AUTOMATED SYNDICATION OF MOBILE CONTENT” and which is a continuation-in-part of U.S. application Ser. No. 11/387,147 filed on Mar. 21, 2006 and entitled “INTERACTION ANALYSIS AND PRIORITIZATION OF MOBILE CONTENT,” which is continuation-in-part of U.S. application Ser. No. 11/355,915 filed on Feb. 16, 2006 and entitled “PRESENTATION OF SPONSORED CONTENT BASED ON MOBILE TRANSACTION EVENT,” which is a continuation of U.S. application Ser. No. 11/347,842 filed on Feb. 3, 2006 and entitled “MULTIMODAL SEARCH QUERY,” which is a continuation of U.S. application Ser. No. 11/347,825 filed on Feb. 3, 2006 and entitled “SEARCH QUERY ADDRESS REDIRECTION ON A MOBILE COMMUNICATION FACILITY,” which is a continuation of U.S. application Ser. No. 11/347,826 filed on Feb. 3, 2006 and entitled “PREVENTING MOBILE COMMUNICATION FACILITY CLICK FRAUD,” which is a continuation of U.S. application Ser. No. 11/337,112 filed on Jan. 19, 2006 and entitled “USER TRANSACTION HISTORY INFLUENCED SEARCH RESULTS,” which is a continuation of U.S. App. No. 11/337,180 filed on Jan. 19, 2006 and entitled “USER CHARACTERISTIC INFLUENCED SEARCH RESULTS,” which is a continuation of U.S. application Ser. No. 11/336,432 filed on Jan. 19, 2006 and entitled “USER HISTORY INFLUENCED SEARCH RESULTS,” which is a continuation of U.S. application Ser. No. 11/337,234 filed on Jan. 19, 2006 and entitled “MOBILE COMMUNICATION FACILITY CHARACTERISTIC INFLUENCED SEARCH RESULTS,” which is a continuation of U.S. application Ser. No. 11/337,233 filed on Jan. 19, 2006 and entitled “LOCATION INFLUENCED SEARCH RESULTS,” which is a continuation of U.S. application Ser. No. 11/335,904 filed on Jan. 19, 2006 and entitled “PRESENTING SPONSORED CONTENT ON A MOBILE COMMUNICATION FACILITY,” which is a continuation of U.S. application Ser. No. 11/335,900 filed on Jan. 18, 2006 and entitled “MOBILE ADVERTISEMENT SYNDICATION,” which is a continuation-in-part of U.S. application Ser. No. 11/281,902 filed on Nov. 16, 2005 and entitled “MANAGING SPONSORED CONTENT BASED ON USER CHARACTERISTICS,” which is a continuation of U.S. application Ser. No. 11/282,120 filed on Nov. 16, 2005 and entitled “MANAGING SPONSORED CONTENT BASED ON USAGE HISTORY”, which is a continuation of U.S. application Ser. No. 11/274,884 filed on Nov. 14, 2005 and entitled “MANAGING SPONSORED CONTENT BASED ON TRANSACTION HISTORY”, which is a continuation of U.S. application Ser. No. 11/274,905 filed on Nov. 14, 2005 and entitled “MANAGING SPONSORED CONTENT BASED ON GEOGRAPHIC REGION”, which is a continuation of U.S. application Ser. No. 11/274,933 filed on Nov. 14, 2005 and entitled “PRESENTATION OF SPONSORED CONTENT ON MOBILE COMMUNICATION FACILITIES”, which is a continuation of U.S. application Ser. No. 11/271,164 filed on Nov. 11, 2005 and entitled “MANAGING SPONSORED CONTENT BASED ON DEVICE CHARACTERISTICS”, which is a continuation of U.S. application Ser. No. 11/268,671 filed on Nov. 5, 2005 and entitled “MANAGING PAYMENT FOR SPONSORED CONTENT PRESENTED TO MOBILE COMMUNICATION FACILITIES”, and which is a continuation of U.S. application Ser. No. 11/267,940 filed on Nov. 5, 2005 and entitled “MANAGING SPONSORED CONTENT FOR DELIVERY TO MOBILE COMMUNICATION FACILITIES,” which is a non-provisional of U.S. App. No. 60/731,991 filed on Nov. 1, 2005 and entitled “MOBILE SEARCH”, U.S. App. No. 60/720,193 filed on Sep. 23, 2005 and entitled “MANAGING WEB INTERACTIONS ON A MOBILE COMMUNICATION FACILITY”, and U.S. App. No. 60/717,151 filed on Sep. 14, 2005 and entitled “SEARCH CAPABILITIES FOR MOBILE COMMUNICATIONS DEVICES”.

It is to be understood that concepts (e.g., behavioral, demographic, contextual, etc. targeting) discussed in the aforementioned specifications may be applied to one or more of the concepts discussed within this application.

What is claimed:

1. A device for analyzing eye data captured via the device, the device comprising a display, a camera, one or more processors, and a memory with instructions stored thereon which, when executed by the one or more processors, causes the device to perform the steps of:
(a) displaying an advertisement and other content on the display;
(b) capturing one or more images using the camera, wherein the one or more images depict at least one or more eyes of a user of the device;
(c) detecting the one or more eyes in the one or more captured images;
(d) determining based at least upon the one or more captured images that the one or more eyes are focused for a predetermined amount of time on the advertisement as opposed to the other content; and
(e) based upon the determination in step (d), displaying on the display an item contextually related to the advertisement and different from the other content, wherein the item is:
(i) text;
(ii) a picture; or
(iii) a video.

2. The device of claim 1, wherein the text comprises additional information about a product or service depicted in the advertisement.

3. The device of claim 1, wherein the device is:
(a) a cellular phone;
(b) a smartphone;
(c) a tablet;
(d) a portable media player;
(e) a laptop or notebook computer;
(f) a smart watch;
(g) smart glasses; or
(h) contact lenses.

4. The device of claim 1, wherein the device comprises an accelerometer and a gyroscope.

5. A device for analyzing eye data captured via the device, the device comprising a display, a camera, one or more processors, and a memory with instructions stored thereon which, when executed by the one or more processors, causes the device to perform the steps of:
(a) displaying an advertisement and other content on the display;
(b) capturing one or more images using the camera, wherein the one or more images depict at least one or more eyes of a user of the device;
(c) detecting the one or more eyes in the one or more captured images;
(d) determining based at least upon the one or more captured images that the one or more eyes are focused for a predetermined amount of time on the advertisement as opposed to the other content; and
(e) based upon the determination in step (d), displaying on the display an expanded version of the advertisement.

6. The device of claim 5, wherein the device is:
(a) a cellular phone;
(b) a smartphone;
(c) a tablet;
(d) a portable media player;
(e) a laptop or notebook computer;
(g) a smart watch;
(g) smart glasses; or
(h) contact lenses.

7. The device of claim 5, wherein the device comprises an accelerometer and a gyroscope.

8. A device for analyzing eye data captured via the device, the device comprising a display, a camera, one or more processors, and a memory with instructions stored thereon which, when executed by the one or more processors, causes the device to perform the steps of:
(a) displaying on the display a webpage containing:
(i) a graphical element depicting an item for which a corresponding or similar real-life item is available for purchase;
(ii) other content;
(b) capturing one or more images using the camera, wherein the one or more images depict at least one or more eyes of a user of the device;
(c) detecting the one or more eyes in the one or more captured images;
(d) determining based at least upon the one or more captured images that the one or more eyes are focused for a predetermined amount of time on the item as opposed to the other content; and
(e) based upon the determination in step (d), displaying on the display content contextually related to the item and different from the other content, wherein the contextually related content is:
(i) an incentive associated with the corresponding or similar real-life item;
(ii) a purchase opportunity for the corresponding or similar real-life item; or
(iii) an availability of the corresponding or similar real-life item within a predefined geographical region associated with the device.

9. The system of claim 8 wherein the item is clothing, a movie, a game, an electronic device, or real estate.

10. The system of claim 8, wherein the incentive is a sales price discount, a coupon, or a merchandise credit.

11. The system of claim 8, wherein the geographical region is a zip code, an area code, a city, or a predefined radius distance.

12. The device of claim 8, wherein the device is:
(a) a cellular phone;
(b) a smartphone;
(c) a tablet;
(d) a portable media player;
(e) a laptop or notebook computer;
(f) a smart watch;
(g) smart glasses; or
(h) contact lenses.

13. The device of claim 8, wherein the device comprises and accelerometer and a gyroscope.
